(19) United States
(12) Patent Application Publication
(10) Pub. No.: US 2015/0149323 A1
(43) Pub. Date: May 28, 2015

(54) METHOD FOR SURFING PURCHASE INFORMATION ON SHOPPING WEBSITE

(71) Applicant: Cheng-Sung WEI, Taipei City (TW)

(72) Inventor: Cheng-Sung WEI, Taipei City (TW)

(21) Appl. No.: 14/089,130

(22) Filed: Nov. 25, 2013

(51) Int. Cl. G06Q 30/06

(52) U.S. Cl. CPC G06Q 30/0631; G06Q 30/0625
USPC 705/26.62; 705/26.7

(57) ABSTRACT

A method for surfing purchase information on a shopping website comprises the steps of: logging into the shopping website by account data of a first user stored in a social network site; displaying a user icon of a second user who has purchased an article before in a recommender display area on an article display page of the shopping website to inform the first user that the second user has purchased the article previously; and clicking the user icon to open a dialog window for conversing and interacting with the second user. As such, the first user further learns the evaluation of the second user on the same article to determine whether to purchase the article or not.

### FIELD OF THE INVENTION

The present invention relates to a surf method, and particularly to a method for surfing purchase information on a shopping website.

### BACKGROUND OF THE INVENTION

The Internet is regarded as one of the main platforms for propagating and sharing information, and online marketplaces are thus developed therefrom. Consumers are enabled to browse product information of articles sold in the online marketplace on a marketplace website. The product information includes basic information such as images, sizes and materials of the articles. Such manner of ordering the articles through online shopping from a supplier is extremely convenient. However, being displayed on the online marketplace through the Internet, the articles cannot be physically seen and touched by a consumer as in a physical store, and thus consumers usually receive articles that do not meet their expectations or receive defective articles. In current circumstances, one can only deduce the quality of the article by depending on the product information displayed and evaluations left by other consumers on the product webpage of the shopping website.

The consumers who left the evaluations on the product webpage of the shopping website are not necessarily correlated with other consumers who are currently browsing the product webpage of the shopping website. That is to say, the consumers who left the evaluations and other consumers who are currently browsing may not be acquainted with one another, and thus levels of understanding and expectation of those consumers may be very different. As a result, the consumers who are currently browsing may not be able to determine whether the article is suitable based on the evaluations. In other cases, the consumers who left the evaluations may be other accounts that belong to the seller, and good evaluations are left by those accounts to attract potential buyers. In conclusion, it is difficult to objectively judge the quality of the article based on the above method.

### SUMMARY OF THE INVENTION

Therefore, the primary object of the present invention is to provide a solution for a user to better determine the quality of articles during online shopping.

To achieve the above object, a method for surfing purchase information on a shopping website is provided. The shopping website acquires data from a social network site. The social network site stores account data and social data of a first user. The social data includes a user icon of at least one second user. The shopping website stores a plurality of purchase tags corresponding to a plurality of articles respectively and shopping data associated with the purchase tag after the at least one second user purchases article on the shopping website. The method for surfing the purchase information on the shopping website includes the steps of: logging in the shopping website by the account data of the first user, and authorizing the shopping website to acquire the social data of the first user; opening an article display page which is associated with the article on the shopping website and includes a purchase link and a recommender display area, looking up the shopping data of the second user according to the purchase tag on the shopping website, and obtaining the user icon from the social data and displaying the user icon in the recommender display area; and clicking the user icon to open a dialog window for conversing and interacting with the second user.

The method for surfing the purchase information on the shopping website further includes a step of entering a search signal into a search field on a homepage of the shopping website to generate a search result which includes an article link for opening the article display page when the article link is clicked.

The method for surfing the purchase information on the shopping website further includes the steps of clicking the purchase link to purchase the article, and generating a questionnaire page after having purchased the article, wherein the questionnaire page includes an option for agreeing to become a recommender of the purchased article and another option for not agreeing to become a recommender of the purchased article.

The step of clicking the purchase link to purchase the article further includes the steps of clicking the purchase link to open a payment page which includes at least one payment form and a purchase confirmation option, and selecting the purchase confirmation option to complete the purchase after filling out the payment form.

The present invention provides the advantages below, The account data of the first user of a social network site is utilized to log in the shopping website, and the user icon of the second user who previously purchased the article is displayed in the recommender display area. As such, the first user may learn the purchased article of the second user and open the dialog window by clicking the user icon to interact and converse with the second user. The first user is enabled to further find out the evaluation of the second user on the article to decide whether to purchase the same article or not.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of shopping website architecture according to a preferred embodiment of the present invention;

FIG. 2 is a flowchart according to a preferred embodiment of the present invention;

FIG. 3 is a schematic diagram of a homepage of a shopping website according to a preferred embodiment of the present invention;

FIG. 4 is a schematic diagram of a login page according to a preferred embodiment of the present invention;

FIG. 5 is a schematic diagram of a search result according to a preferred embodiment of the present invention;

FIG. 6 is a schematic diagram of an article display page according to a preferred embodiment of the present invention;

FIG. 7 is a schematic diagram of a dialog window according to a preferred embodiment of the present invention;

FIG. 8 is a schematic diagram of a payment page according to a preferred embodiment of the present invention; and

FIG. 9 is a schematic diagram of a questionnaire page according to a preferred embodiment of the present invention.

### DETAILED DESCRIPTION OF THE PREFERRED EMBODIMENTS

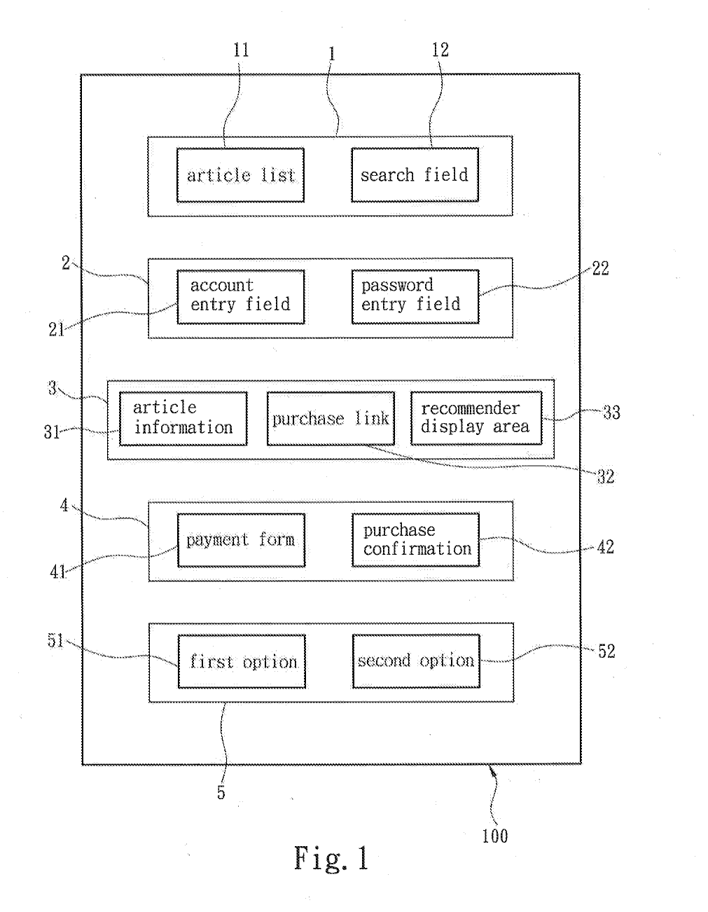

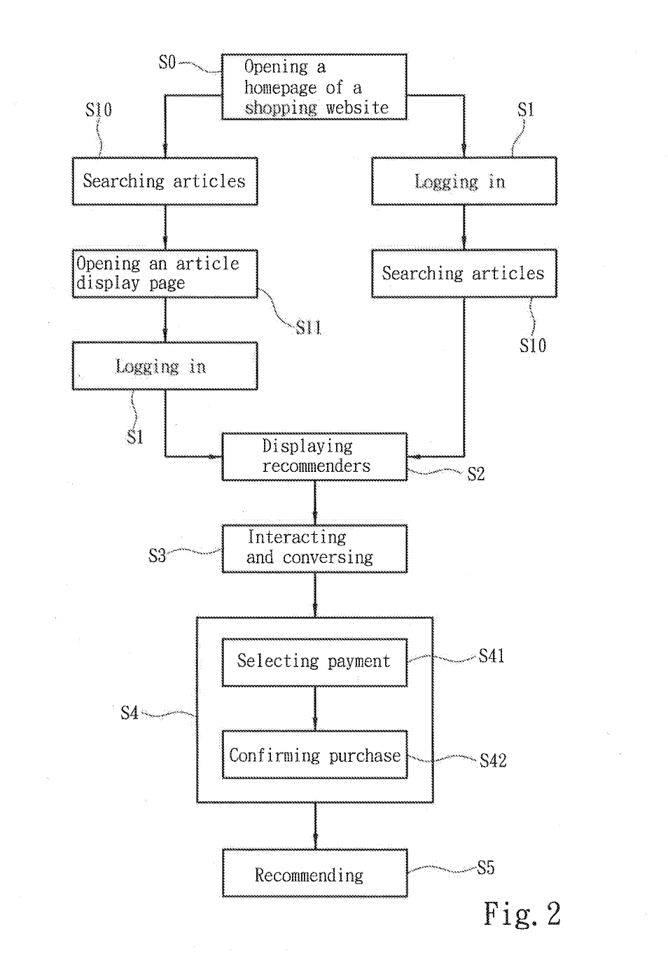

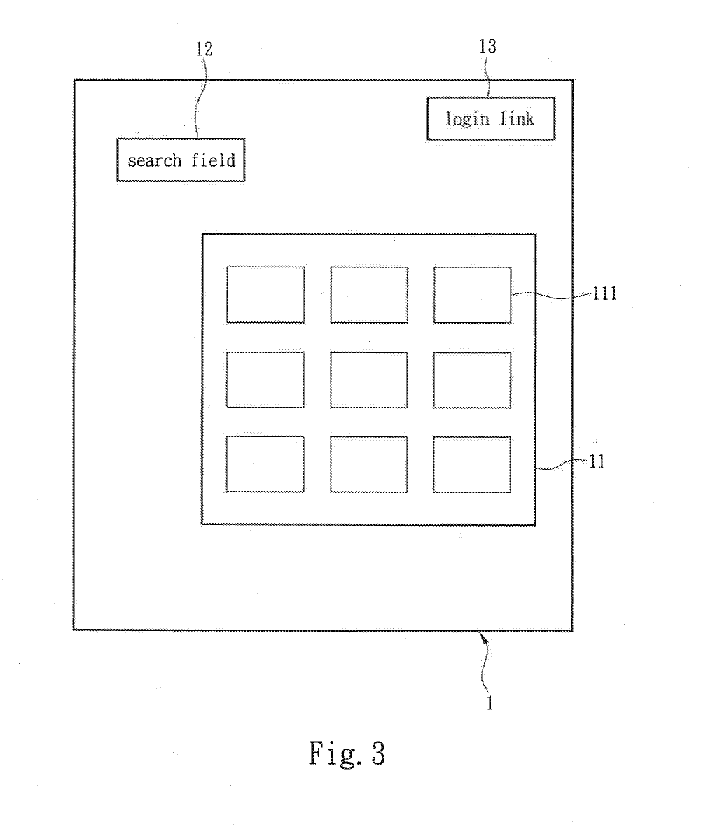

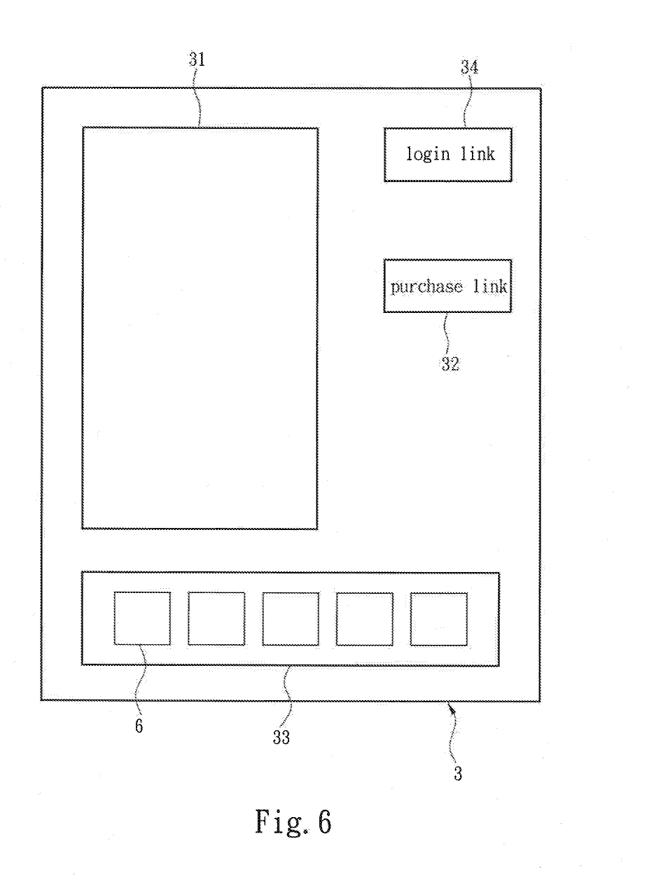

FIGS. 1 and 2 are a schematic diagram of shopping website architecture and a flowchart, respectively. As shown, a method for surfing purchase information on a shopping website is provided. The shopping website 100 acquires data from a social network site. For example, the shopping website 100 may be Yahoo auction or Ebay auction, while the social network site may be Facebook, Google+ or Twitter. The shopping website 100 includes a homepage 1, a login page 2 for a user to log in, an article display page 3, a payment page 4 for a user to select a payment way, and a questionnaire page 5. The login page 2 includes an account entry field 21 and a password entry field 22. The homepage 1 includes an article list 11 containing a plurality of article icons 111 (as shown in FIG. 3), a search field 12 and a login link 13 for opening the login page 2 when being clicked. The article display page 3 includes article information 31, a purchase link 32 and a recommender display area 33. The social network site stores account data and social data of a first user. The social data includes a user icon 6 (as shown in FIG. 6) of at least one second user. More specifically, the first user and the second user are friends in the social network site. The shopping website 100 stores a plurality of purchase tags corresponding to a plurality of articles respectively, and shopping data associated with the purchase tag after the at least one second user purchases the article on the shopping website 100.

The method for surfing the purchase information on the shopping website 100 includes the following steps.

In step S1, the account data of the first user is utilized to login the shopping website 100, and the shopping website 100 is authorized to acquire the social data of the first user.

In step S2, the article display page 3 associated with the article is opened from the shopping website 100. The article display page 3 includes the purchase link 32 and the recommender display area 33. The shopping data of the second user is looked up according to the purchase tag on the shopping website 100, and the user icon 6 is obtained from the social data and displayed in the recommender display area 33.

In step S3, the user icon 6 is clicked to open a dialog window 7 for conversing and interacting with the second user.

Details of the method for surfing the purchase information on the shopping website of the present invention are given with reference to FIGS. 2 to 9 below.

In step S0, the homepage 1 of the shopping website 100 is opened. The homepage 1 includes the article list 11 containing the article icons 111, the search field 12 and the login link 13 (as shown in FIG. 3).

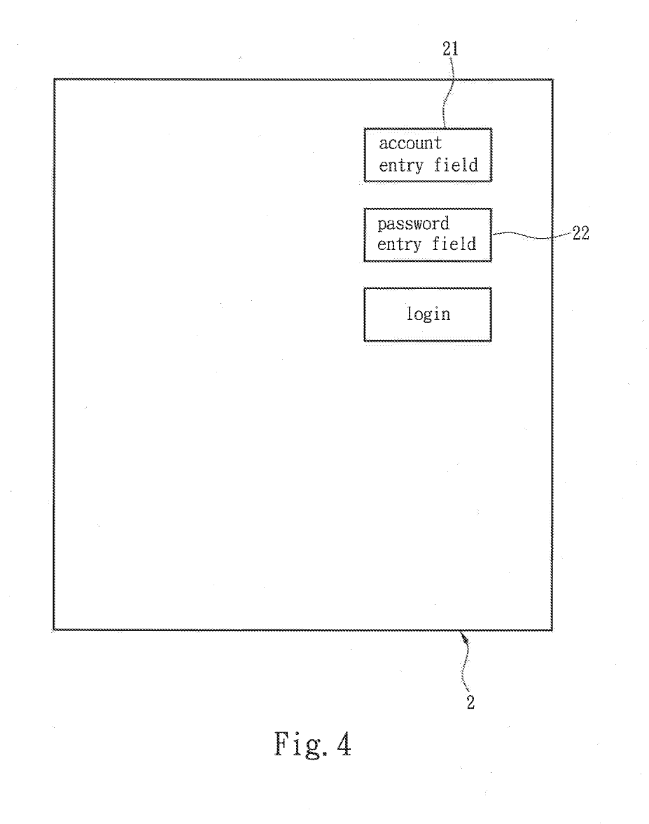

The login link 13 is clicked to open the login page 2 to proceed to step S1, in which the account data of the first user is utilized to login the shopping website 100 and the shopping website 100 is authorized to acquire the social data of the first user. The account data includes an account and a password. The first user, enters the account and the password into the account entry field 21 and the password entry field 22 respectively to log into the shopping website 100. After logging in, the social network site authorizes the shopping website 100 to acquire the social data of the first user (as shown in FIG. 4).

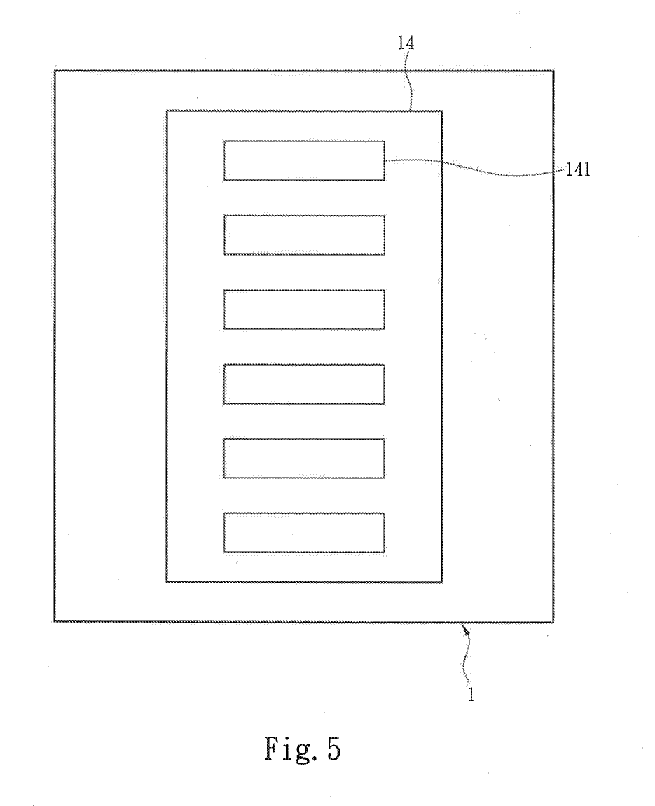

After successfully logging into the shopping website 100, the screen is automatically returned to the homepage 1, and step S10 is next performed. In step S10, a search signal is entered into the search field 12 on the homepage 1 of the shopping website 100 to generate a search result 14. For example, the search signal is a keyword or an article code. The search result 14 includes an article link 141 (as shown in FIG. 5) of the article.

The article link 141 is clicked to proceed to step S2. In step S2, the article display page 3 associated with the article is opened on the shopping website 100. The article display page 3 includes the article information 31 of the articles, the purchase link 32 and the recommender display area 33. The article information 31 may include information such as images, specification, color, expiration date and price of the article. According to the purchase tag, the shopping data of the second user is looked up on the shopping website 100, and the user icon 6 is obtained from the social data and displayed in the recommender display area 33 (as shown in FIG. 6).

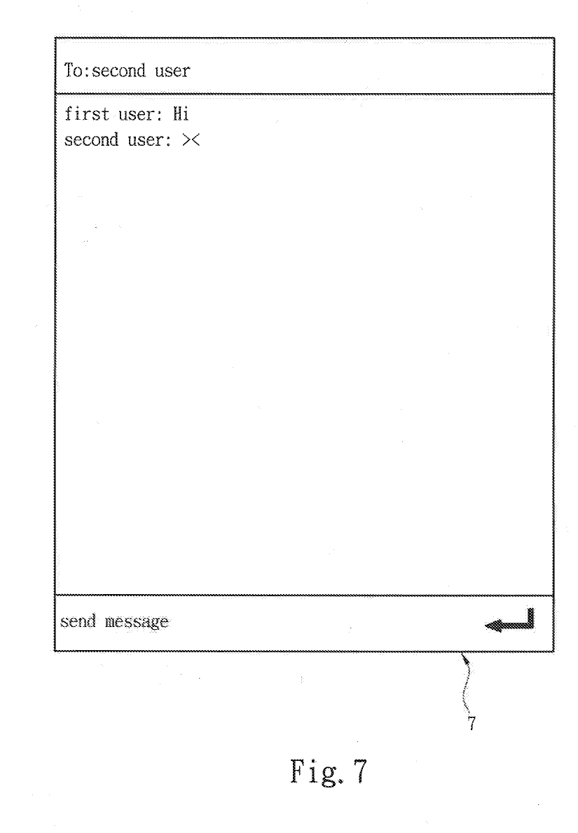

In step S3, the user icon 6 is clicked to open the dialog window 7 for conversing and interacting with the second user. The first user is enabled to interact and converse with the second user through the dialog window 7 to obtain the evaluation of the second user on the purchased article to determine whether to purchase the same article or not according to the evaluation. The dialog window 7 may be opened on the social network site (as shown in FIG. 7).

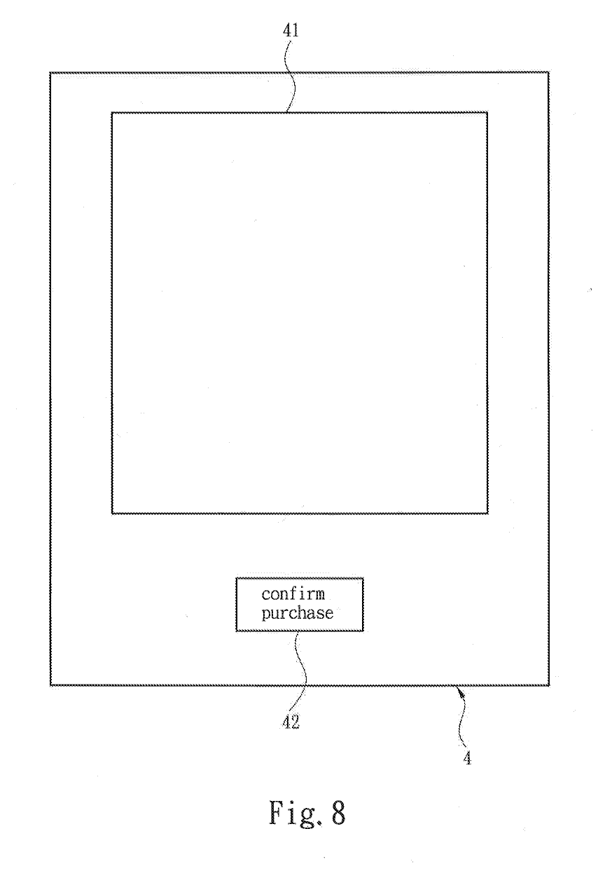

When the first user decides to purchase the article, step S4 is performed. In step S4, the purchase link 32 is clicked to purchase the article. The step S4 further includes step S41 and step S42. In step 541, the purchase link 32 is clicked to open the payment page 4 which includes at least one payment form 41 and a purchase confirmation option 42. In step S42, the payment form 41 is filled out and the purchase confirmation option 42 is selected to complete the purchase (as shown in FIG. 8).

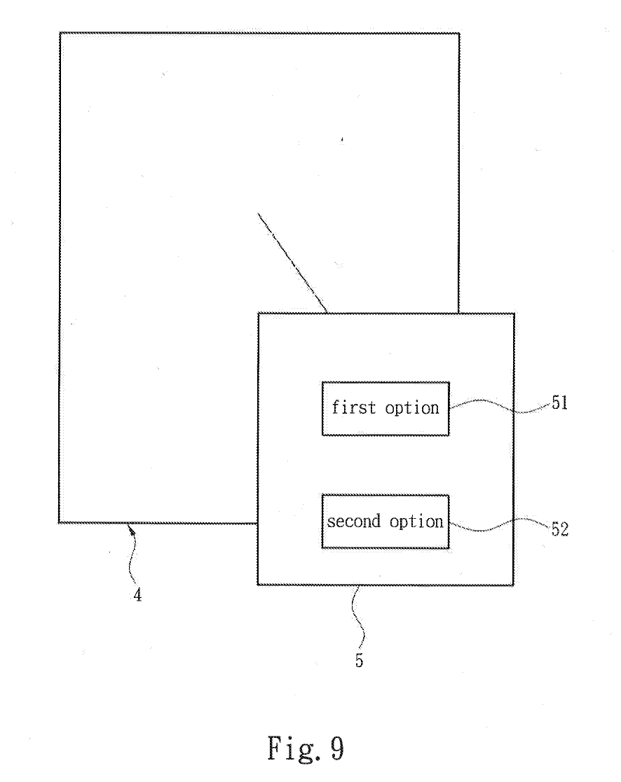

In step S5, the questionnaire page 5 is generated after the article is purchased. The questionnaire page 5 includes a first option 51 of agreeing to become a recommender of the article, and a second option 52 of not agreeing to become a recommender of the article. When the first user selects the first option 51, the shopping website 100 stores the shopping data of the first user having purchased the article, and associates the shopping data to the purchase tag of the article. As such, the first user and the second user have both become the recommenders of the article. In contrast, when the first user selects the second option 52, the shopping website 100 does not associate the shopping data of the first user having purchased the article to the purchase tag of the article (as shown in FIG. 9). After selecting the options on the questionnaire page 5, the questionnaire page 5 then automatically closes and is returned to the article display page 3 to allow the first user to continue shopping.

Referring to FIG. 2, in another embodiment, step S10 may be first performed after the homepage 1. of the shopping website 100 is opened in step S0. In step S10, the search signal is entered in the search field 12 on the homepage 1 of the shopping website 100 to generate the search result 14 including the article link 141 of the article. Step S 11 is proceeded after the article link 141 is clicked to open the article display page 3. The article display page 3 includes the article information 31, the purchase link 32 and the recommender display area 33 of the article, and a login link 34. At this point, since the first user does not log into the shopping website 100, the social network site has not yet authorized the shopping website 100 to acquire the social data of the first user. As such, the shopping website 100 is unable to look up the shopping data of the second user, and the recommender display area 33 appears blank (not shown) as the user icon 6 of the second user is not available for display. The login link 34 is clicked to open the login page 2 to proceed to step S1. In step S1, the account data of the first user is utilized to log into the shopping website 100 and the shopping website 100 is authorized to acquire the social data of the first user. The first user enters the account and the password into the account entry field 21 and the password entry field 22 respectively to log into the shopping website 100. After logging in, the social network site authorizes the shopping website 100 to acquire the social data of the first user. Step S2 is automatically performed after successfully logging into the shopping website 100 to open. the article display page 3. The article display page 3 includes the article information 31, the purchase link 32 and the recommender display area 33 of the article. It should be noted that the login link 34 is automatically removed from the article display page 3 after logging in. The shopping data of the second user is looked up according to the purchase tag on the shopping website 100, and the user icon 6 is obtained from the social data and displayed in the recommender display area 33. In the following step S3, the user icon 6 is clicked to open the dialog window 7 for conversing and interacting with the second user. Thus, the first user is enabled to interact and converse with the second user through the dialog window 7 to obtain the evaluation of the second user on the purchased article to determine whether to purchase the same article or not according to the evaluation. When the first user decides to purchase the article, steps S41 and S42 are performed. The purchase link 32 is clicked to open the payment page 4, the payment form 41 is filled out, and the purchase confirmation option 42 is selected to complete the purchase. Step S5 is then performed to generate the questionnaire page 5 after the article is purchased. When the first user selects the first option 51, the shopping website 100 stores the shopping data of the first user having purchased the article, and associates the shopping data to the purchase tag of the article. As such, the first user and the second user have both become the recommenders of the article. In contrast, when the first user selects the second option 52, the shopping website 100 does not associate the shopping data of the first user having purchased the article to the purchase tag of the article. After selecting the options on the questionnaire page 5, the questionnaire page 5 then automatically closes and is returned to the article display page 3 to allow the first user to continue shopping.

With the present invention, the first user may log into the shopping website 100 by using the account data of the first user in the social network site, and the user icon 6 of the second user who previously purchased the article can be shown in the recommender display area 33. Thus, the first user may learn the purchased article of the second user, and click the user icon 6 to open the dialog window 7 to interact and converse with the second user. Through the dialog window 7, the first user may further find out the evaluation of the second user on the article to determine whether to purchase the same article or not according to the evaluation. After purchasing the article, the first user may become the recommender of this article and provide an evaluation associated with the article to acquaintances of the first user.

What is claimed is:

1. A method for surfing purchase information on a shopping website, the shopping website acquiring data from a social network site, the social network site storing account data and social data of a first user, wherein the social data includes a user icon of at least one second user, the shopping website storing a plurality of purchase tags corresponding to a plurality of articles respectively and shopping data associated with the purchase tag after the at least one second user purchases the article on the shopping website; the method comprising the steps of:
logging into the shopping website by the account data of the first user, and authorizing the shopping website to acquire the social data of the first user;
opening an article display page which is associated with the article on the shopping website and includes a purchase link and a recommender display area, looking up the shopping data of the second user according to the purchase tag on the shopping website, and acquiring the user icon from the social data and displaying the user icon in the recommender display area; and
clicking the user icon to open a dialog window for conversing and interacting with the second user.

2. The method of claim 1 further comprising a step of entering a search signal into a search field on a homepage of the shopping website to generate a search result which includes an article link for opening the article display page when the article link is clicked.

3. The method of claim 1 further comprising the steps of clicking the purchase link to purchase the article, and generating a questionnaire page after having purchased the article, wherein the questionnaire page includes an option of agreeing to become a recommender of the article and another option of not agreeing to become the recommender of the article.

4. The method of claim 3 further comprising the steps of clicking the purchase link to open a payment page which includes at least one payment form and a purchase confirmation option, and selecting the purchase confirmation option to complete purchase after filling out the payment form.
